(19) United States
(12) Patent Application Publication
(10) Pub. No.: US 2006/0129483 A1
(43) Pub. Date: Jun. 15, 2006

(54) Method for transacting a trade electronically, and a system therefor

(76) Inventors: Philip Course, Melbourne (AU); Gregory Douglas McCreath, Melbourne (AU)

Correspondence Address: MCDERMOTT WILL & EMERY LLP;ATTN: INTELLECTUAL PROPERTY DEPTARTMENT DOCKETING, 28 STATE STREET, BOSTON, MA, 02109, US

(21) Appl. No.: 10/519,907

(22) PCT Filed: Jun. 27, 2003
(86) PCT No.: PCT/AU03/00846

§ 371 Date: Dec. 15, 2005

(30) Foreign Application Priority Data
Jun. 28, 2002 (AU) PS 3312

(51) Int. Cl. G06Q 40/00

(52) U.S. Cl. 705/40

(57) ABSTRACT

A method for electronically transacting a trade between a commercial provider and a customer of a merchant. The method is also for electronically paying all of the participants involved with enabling the transaction from the payment made by the customer in consideration of the trade. The method involves entering into agreements for valuable or other consideration with (i) the commercial provider for providing a good or service to a potential customer of the merchant; and (ii) the merchant for offering the good or service of the commercial provider to its customers. Thereafter, the method involves: electronically transacting with the customer of the merchant the provision of the good or service of the commercial provider to the customer; using an electronic payment system to handle payment of a good or service of the commercial provider purchased by the customer; electronically authorising the provision of the good or service of the commercial provider upon confirmation of payment by the electronic payment system; electronically distributing the valuable consideration in respect of the payment to the commercial provider and to the merchant, in accordance with the respective agreements made. A system for performing the aforementioned method is also described.

### FIELD OF THE INVENTION

This invention relates to a method for electronically transacting a trade between a customer and a commercial provider, and a system therefor. The invention has particular utility with existing electronic funds transfer (EFT) systems used by merchants and banking systems or organisations that act on their behalf, and is concerned with extending the range of services and commercial providers that may be offered by merchants making use of such EFT systems to their customers for increasing business.

Throughout the specification, unless the context requires otherwise:
“comprise” or variations such as “comprises” or “comprising”, will be understood to imply the inclusion of a stated integer or group of integers but not the exclusion of any other integer or group of integers;
“EFTPOS” is an acronym for Electronic Funds Transfer Point Of Sale;
“commercial provider” is defined to mean a provider of a service or a product, or a combination of both, to a customer;
“business broker” is defined to mean an entity that controls a business transaction between a customer requiring a service or product and a commercial provider of that service product.
“payment system” is defined to mean any acquiring banking system for providing the transfer of funds.

### BACKGROUND ART

Presently, merchants use EFT or EFTPOS terminals to facilitate customer payment of goods or services purchased. However, the EFT or EFTPOS terminals may be sponsored by the merchant, a business broker or a financial institution.

Where the EFT or EFTPOS terminal is sponsored by a business broker, the business broker establishes a contractual relationship with the merchant and a financial institution. The financial institution provides EFT or EFT-related services that allow the merchant's customers to electronically transfer the funds required for payment of the goods or services purchased from an account they have with a particular financial institution to the merchant.

Where the EFT or EFTPOS terminal is sponsored by a financial institution, the financial institution provides EFT services to the merchant's customers and acts as the acquiring bank. In such situations, the financial institution establishes a contractual relationship with other financial institutions and specific credit card associates to provide for the electronic transfer of funds in relation to the trade of select merchants or brokers of EFT services to the merchant's customers.

In situations where the EFT or EFTPOS terminal is sponsored by a business broker or a financial institution, a percentage of the funds transferred from the customer's account may be indirectly paid to the terminal sponsor as a commission. In situations where the terminal sponsor is not paid a commission, the terminal sponsor typically acts on behalf of the financial institution and receives a fixed fee for doing so (the fee being calculated on some agreed upon basis).

If the payment made by the merchant's customer is by means of a credit card, a further percentage of the funds transferred from the customer's account, or a further fixed fee again being calculated on some agreed upon basis, may be paid to the credit card service provider.

While this payment structure seems relatively simple, in practical terms, there are millions of electronic transactions processed daily, and this increases the complexity of the system by several orders of magnitude. This arrangement also makes the inclusion of additional parties into the payment structure a problematic task and thereby limits the ability of merchants to offer third-party ancillary goods and services, such as government and utility bill payments, to their customers through their EFT or EFTPOS terminals.

Accordingly, the present invention is concerned with providing a workable system and methodology for merchants to provide third-party ancillary goods and services to their customers using their existing payment infrastructure.

### DISCLOSURE OF THE INVENTION

It is an object of the present invention to provide for transacting a trade involving a product or service provided by a commercial provider to a customer using an EFT terminal of a merchant, where the commercial provider may be remote of the merchant.

In accordance with one aspect of the present invention, there is provided a A method for electronically transacting a trade between a commercial provider and a customer of a merchant, and for electronically paying all of the participants involved with enabling the transaction from the payment made by the customer in consideration of the trade, the method comprising:
entering into an agreement with the commercial provider to provide a good or service to a potential customer of the merchant for valuable or other consideration;
entering into an agreement with the merchant to offer the good or service of the commercial provider to its customers for valuable or other consideration;
electronically transacting with the customer of the merchant the provision of the good or service of the commercial provider to the customer;
using an electronic payment system to handle payment of a good or service of the commercial provider purchased by a customer of the merchant;
electronically authorising the provision of the good or service of the commercial provider upon confirmation of payment by the electronic payment system;
electronically distributing the valuable consideration in respect of the payment to the commercial provider, if applicable, in accordance with the agreement made with the commercial provider; and
electronically distributing the valuable consideration in respect of the payment to the merchant, if applicable, in accordance with the agreement made with the merchant.

Preferably, the method further comprises the steps of:
entering into an agreement with a sponsor of a terminal device of the electronic payment system to use the terminal device in handling payment for a good or service of the commercial provider purchased by a customer of the merchant, agreement being provided in return for a prescribed proportion of the price of the good or service or fixed sum;
   electronically distributing the prescribed proportion or fixed sum of the payment to the sponsor of the terminal device in accordance with the agreement made with the sponsor of the terminal device.

Preferably, method includes the step of using an electronic payment system to handle payment of a good or service of the commercial provider purchased by a customer of the merchant includes the sub-step of electronically drawing on an electronic bank account of the merchant to pay for the good or service of the commercial provider purchased by the customer.

In accordance with another aspect of the present invention, there is provided a method for electronically transacting a trade between a commercial provider and a customer of a merchant, and for electronically paying all of the participants involved with enabling the transaction from the payment made by the customer in consideration of the trade, the method comprising:
entering into an agreement with the commercial provider to provide a good or service to a potential customer of the merchant for a prescribed proportion of the price of the good or service or for a fixed sum;
entering into an agreement with a sponsor of a terminal device of an electronic payment system to use the terminal device in handling payment for a good or service of the commercial provider purchased by a customer of the merchant, agreement being provided in return for a prescribed proportion of the price of the good or service or fixed sum;
electronically transacting with the customer the provision of the good or service of the commercial provider to a customer of the merchant;
using the electronic payment system to handling payment of a good or service of the commercial provider purchased by a customer of the merchant;
electronically authorising the provision of the good or service of the commercial provider upon confirmation of payment by the electronic payment system;
electronically distributing the prescribed proportion or fixed sum of the payment to the commercial provider in accordance with the agreement made with the commercial provider; and
   electronically distributing the prescribed proportion or fixed sum of the payment to the owner of the terminal device in accordance with the agreement made with the sponsor of the terminal device.

Preferably, the terminal device is one of an EFT terminal, a mobile telephone or portable digital assistant.

Preferably, the primary payment for the good or service is paid for by way of an electronic transfer of funds from the payment system associated with the EFT terminal.

Preferably, the provider of the electronic authorising to the commercial provider for the provision of the good or service, the provider of the electronic transacting with the customer for the provision of the good or service to the customer, and the provider of the electronic distributing of the valuable consideration to the commercial provider and the merchant, if applicable, with the payment system, is the same provider.

Preferably, the provider contracts with the merchant to pay the merchant a sales commission for a good or service that the merchant is able to sell or provide to a customer.

Preferably, the merchant pays a fee to the provider for the provision of a good or service that adds value to the merchant's business.

Preferably, the primary payment for the provision of a good or service is paid for by way of an electronic transfer of funds from a payment system associated with the business broker.

Preferably, primary payment for the service or product may be paid for directly by the customer.

Preferably, the terminal device communicating the particular manner of the transacting payment to the provider, and the provider effecting the electronic distribution of the prescribed proportion based on the manner of such payment.

In accordance with a further aspect of the present invention, there is provided a system for electronically transacting a trade comprising:
a business broker who has entered into an agreement with:—
   a. a commercial provider for the commercial provider to provide a good or service to a potential customer of a merchant for a prescribed proportion of the price of the good or service or for a fixed sum;
   b. the merchant for the merchant to offer the good or service of the commercial provider to its customers for a prescribed proportion of the price of the good or service or fixed sum;
an electronic payment system for handling payment of a good or service of the commercial provider purchased by a customer of the merchant
   where, the merchant authorises the provision of the good or service of the commercial provider upon confirmation of payment by the electronic payment system; and where the business broker receives the payment handled by the electronic payment system and electronically distributes the prescribed portion or fixed sum of the payment to the commercial provider in accordance with the agreement made with the commercial provider and electronically distributes the prescribed portion or fixed sum of the payment to the merchant in accordance with the agreement made with the merchant.

Preferably, the electronic payment system includes at least one terminal device.

Preferably, the at least one terminal device is one of: EFT terminal; mobile phone; personal digital assistant.

Preferably, the business broker has also entered into an agreement with an owner of the at least one terminal device to use the terminal device in handling payment for a good or service of the commercial provider purchased by a customer of the merchant, agreement being provided in return for a prescribed proportion of the price of the good or service or fixed sum and where the commercial provider electronically distributes the prescribed portion or fixed sum of the payment to the merchant in accordance with the agreement made with the merchant.

Preferably, the electronic payment network draws on an electronic bank account of the merchant to pay for the good or service of the commercial provider purchased by the customer.

In accordance with a further aspect of the present invention, there is provided a system for electronically transacting a trade comprising:
a business broker who has entered into an agreement with:—
   a. a commercial provider for the commercial provider to provide a good or service to a potential customer of a merchant for a prescribed proportion of the price of the good or service or for fixed sum;
   b. an owner of a terminal device of an electronic payment system to use the terminal device in handling payment for a good or service of the commercial provider purchased by a customer of a merchant, agreement being provided in return for a prescribed proportion of the price of the good or service or for a fixed sum;
an electronic payment system for handling payment of a good or service of the commercial provider purchased by a customer of the merchant
   where, the merchant authorises the provision of the good or service of the commercial provider upon confirmation of payment by the electronic payment system; and where the business broker receives the payment handled by the electronic payment system and electronically distributes the prescribed portion or fixed sum of the payment to the commercial provider in accordance with the agreement made with the commercial provider and electronically distributes the prescribed portion or fixed sum of the payment to the owner of the terminal device in accordance with the agreement made with the owner of the terminal device.

Preferably, the electronic payment network draws on an electronic bank account of the merchant to pay for the good or service of the commercial provider purchased by the customer.
1. In accordance with another aspect of the present invention, there is provided a system for electronically transacting a trade comprising:
   a business broker who has entered into an agreement with:—
      a. a commercial provider for the commercial provider to provide a good or service to a potential customer of a merchant for a prescribed proportion of the price of the good or service or for fixed sum;
      b. an owner of a terminal device of an electronic payment system to use the terminal device in handling payment for a good or service of the commercial provider purchased by a customer of a merchant, agreement being provided in return for a prescribed proportion of the price of the good or service or for a fixed sum;
   an electronic payment system for handling payment of a good or service of the commercial provider purchased by a customer of the merchant
      where, the merchant authorises the provision of the good or service of the commercial provider upon confirmation of payment by the electronic payment system; and where the business broker receives the payment handled by the electronic payment system and electronically distributes the prescribed portion or fixed sum of the payment to the commercial provider in accordance with the agreement made with the commercial provider and electronically distributes the prescribed portion or fixed sum of the payment to the owner of the terminal device in accordance with the agreement made with the owner of the terminal device.

In accordance with a further aspect of the invention, there is provided a system for electronically transacting a trade between a commercial provider and a customer of a merchant and for electronically paying all of the participants involved with enabling the transaction from the payment made by the customer in consideration of the trade, the system comprising:
a host transaction engine for controlling electronic transactions between a business broker, a merchant, a customer of the merchant, a commercial service provider and a terminal device sponsor;
a terminal device for connection to the host transaction engine, the terminal device being provided with the merchant and associated with a payment system established with the terminal device by a sponsor thereof for the purposes of performing electronic transactions in connection with the trade of the merchant; and
a provider system for connection to the host transaction engine, the provider system being adapted to provide for communications between the host transaction engine and the commercial provider to enable the provision of a transacted service or product;
wherein the host transaction engine has enabling means to electronically enable the provision of the transacted service or product by the commercial provider in response to confirmation of the customer paying for the same; and
   said host transaction means has paying means to electronically account for an distribute prescribed portions of funds to the commercial provider, the merchant and the business broker in accordance with predetermined contractual arrangements with these parties.

Preferably, the terminal device is an EFT terminal. Alternatively, the device may be a mobile telephone or portable digital assistant.

Preferably, the host transaction engine also provides for an electronic transfer of funds from the payment system in response to a transaction in relation to the provision of a commercial provider's service or product. In such cases, a payment system is connected to the host transaction engine, the host transaction engine being adapted to provide for communications with the payment system to enable payment for a transacted service or product.

Preferably, primary payment for the provision of the service or product transacted is effected directly between the terminal device of the merchant and the payment system, wherein the host transaction engine effects subsequent payment of the commercial provider and the terminal sponsor.

Preferably, the system includes a payment system server for connection to the host transaction engine, the payment system server providing for an electronic transfer of funds from the payment system in response to a transaction in relation to the provision of a service or product communicated between the EFT terminal and the host transaction engine, and between the host transaction engine and the payment system, as authorised by the payment system.

Preferably, the host transaction engine performs the control in accordance with an automated Process Model prescribed for transactions concerning the particular commercial provider.

Preferably, the host transaction engine distributes prescribed proportions of the electronic transferred funds in accordance with agreed upon arrangements with the commercial provider, the merchant, the terminal sponsor and the business broker.

Preferably, the business broker is the provider of the electronic transacting for the provision of the service or product with the sponsor of the terminal device.

Preferably, the business broker is the provider of the electronic enabling of the transacted service or product with the commercial provider.

Preferably, the business broker is the provider of the electronic distribution of the funds with the payment system.

Preferably, the primary payment for the service or product is paid for by way of an electronic transfer of funds from the payment system associated with the EFT terminal or a payment system associated with the business broker. Alternatively, primary payment for the service or product may be paid for directly by the customer. In either case, preferably the terminal device communicates the particular manner of the transacting payment to the host transaction engine, and the host transaction engine effects the electronic distribution of the prescribed proportion based on the manner of such payment.

In accordance with another aspect of the invention, there is provided a host transaction engine comprising:
a process automation engine; and
at least one adapter for receiving a message;
   where the at least one adapter translates the message into a format able to be processed by the process automation engine and the process automation engine processes the message in accordance with a predetermined process model.

### BRIEF DESCRIPTION OF THE DRAWINGS

The invention will be better understood in the light of the following description of one specific embodiment thereof. The description is made with reference to the following drawings, wherein:—

FIG. 1 is a block diagram of the general system showing the participants and the general infrastructure involved in transacting a trade in accordance with the present embodiment;

FIG. 2 is a block diagram/flow chart showing the main functional components of the business system;

FIG. 3 is a block diagram showing the main components of the host transaction engine and its deployment;

FIG. 4 is a screen display of a process modelled using the host Process Model of the host transaction engine;

FIG. 5 is screen display of a dialog box showing the message destinations as entered into the graphical process designer;

FIG. 6 is a screen display of a table showing the input and output message locations of the message designer; and

FIG. 7 is a block diagram/flow chart of the bill payment example described herein.

### BEST MODE(S) FOR CARRYING OUT THE INVENTION

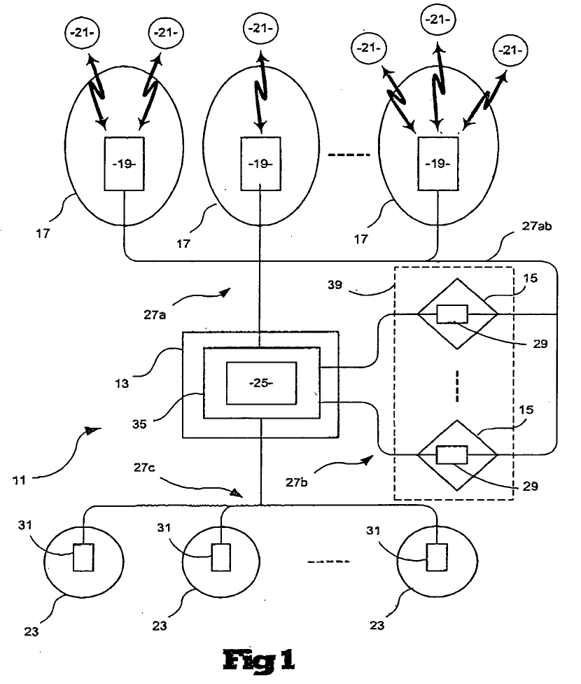

The best mode for carrying out the invention is described in the following specific embodiment directed towards a business system. The business system 11, as shown in FIG. 1 of the drawings, comprises various participants including:
a business broker 13 that operates the business system;
a payment system involving particular financial institutions 15 that provide for the electronic transfer of funds in respect of trading transacted over a communications network;
various merchants 17 that either own EFT terminals 19 or subscribe to the use of same to enable payment of goods or services traded by the merchants;
customers 21 of the merchants 17 that purchase the goods or services traded by the merchants; and
various commercial providers 23 that trade goods or services ancillary to the trade of the merchant 17 to the customers 21 of the merchant, and which are transacted over the network from a remote location.

Although not shown, the business system 11 also includes a terminal sponsor who contracts with or is an acquiring financial institution 15. The acquiring financial institution 15 has contractual agreements with various issuing financial institutions that have bank accounts of prospective customers 21 of merchants 17. Alternatively, or supplementary, the acquiring financial institution 15 has contractual agreements with credit card providers that have access to other issuing financial institutions that have banking accounts of prospective customers 21 of merchants 17.

In the case of a terminal sponsor not being a merchant 17, the terminal sponsor markets the use of their EFT terminals 19 to merchants 17 desirous of allowing customers 21 to use electronic funds transfer to pay for goods or services purchased from the merchant 17. Such EFT terminals 19 are configured for secure data communications with the payment system. A merchant 17 acquiring such an EFT terminal 19 is appropriately licensed by the terminal sponsor and contractually bound to use the EFT terminal 19 only in a secure manner.

In the case of the terminal sponsor being a merchant 17, such as in the case of a major retailer, there is no need for a contractual arrangement between terminal sponsor and merchant 17. Accordingly, in this situation, the merchant 17 takes on the responsibilities of the terminal sponsor in establishing a contractual agreement with the various financial institutions and/or credit card providers previously referred to. The merchant 17 is also responsible for configuring communication with the payment system.

The business broker 13, usually, but not essentially, is a party who:
has a customer base made up of terminal sponsors;
is normally concerned with the supply and maintenance of EFT terminals 19 to terminal sponsors; and
is concerned with the communication between the EFT terminals at a merchant site and the payment system.

In the present embodiment, the business broker 13 markets the business system 11 to prospective commercial providers 23 who provide goods or services ancillary to the goods or services provided by merchants 17 who utilise the EFT terminals 19 of its customer base of terminal sponsors. Examples of these ancillary services include the provision of tickets to particular entertainment venues, lottery tickets, government and utility bill paying services, vouchers, etc. Commercial providers 23 who agree to be part of the business system enter into a contract with the business broker 13 (hereafter referred to as a “broking agreement”) to provide their respective goods and/or services through the EFT terminals 19 of the business broker's 13 customer base of terminal sponsors.

Once a portfolio of commercial providers 23 is established, the business broker 13 markets the goods and services of these commercial providers 23 to its customer base of terminal sponsors. Terminal sponsors who agree to be part of the business system enter into a contract with the business broker 13 (hereafter referred to as a “service agreement”) to allow them to offer goods and/or services of commercial providers 23 to customers through their EFT terminals 19. In some cases, selected merchants 17 may also be required to enter into a service agreement with the business broker 13 to allow the goods and/or services of commercial providers 23 to be offered to their customers via the EFT terminals 19.

Once the required broking and service agreements have been put into place, an automated Process Model prescribed for transactions concerning a particular commercial provider 23, terminal sponsor and/or merchant 17 is implemented on the business system 11. The Process Model is tested, and after successful testing, made active. The active Process Model immediately allows for business transactions to be made concerning the new commercial provider 23, terminal sponsor and/or merchant 17, without detracting from the previous and on-going operation of the business system 11.

In this manner, the business system 11 can undergo “live” updates. Furthermore, it should be made clear that the business system 11 may have more than one active Process Model, although each Process Model will differ in its relationship between commercial provider 23, terminal sponsor and/or merchant 17.

In addition to setting out the contractual relationships between the various parties, the broking and service agreements are also concerned with establishing a payment system between parties. This payment system devolves from the funds transferred from a customer's banking account for payment of a particular service or product transacted with the EFT terminal 19 of the merchant 17 in question.

In the embodiment presently described, the payment system centres on the business broker 13, but stems from payment received by the commercial provider 23 from the customer 21 for the provision of the good or delivery of the service provided by the commercial provider 23. In other embodiments, however, the payment system may stem from payment received by the merchant 17 directly from the customer 21, e.g. by way of cash payment, and not by way of electronic transfer of funds using the payment system associated with the EFT terminal 19.

In the case of customer payments made using the payment system associated with the EFT terminal 19, the payment is one from a banking account of the customer 21 to the banking account of the commercial provider 23, by way of the business broker 13. In the case of customers directly paying the merchant 17, the payment is one from a banking account of the merchant 17 to the banking account of the commercial provider 23, again by way of the business broker 13.

In either case, once payment for the product or service is made, the commercial provider 23 pays a commission to the business broker 13. The business broker 13 then proceeds to pay a commission to the merchant 17, whose customer 21 purchased the particular product or service. The business broker 13 may, if appropriate, also pay a commission to the terminal sponsor, whose EFT terminal 19 and payment system was used to enable the transaction. At the discretion of the parties involved, commissions may be paid on a per transaction or other basis, such as end-of-day.

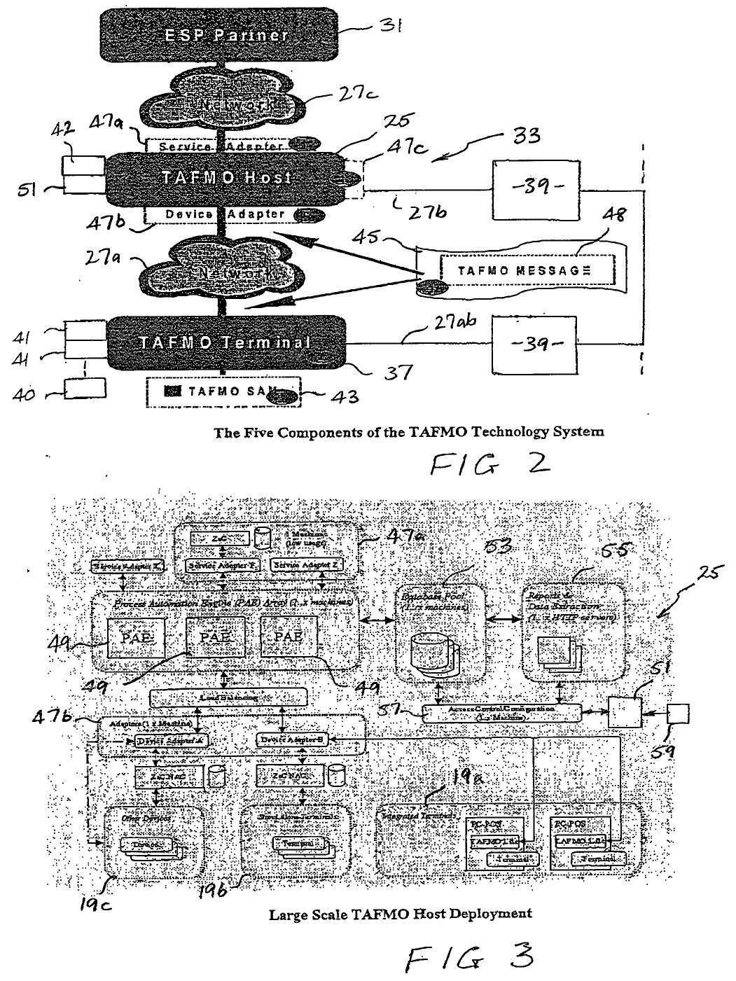

The technical infrastructure 33 of the business system 11, as illustrated in FIGS. 1 and 2, comprises:
a host transaction engine 25 for running on a host server 35. The host server 35 is connected to EFT terminals 19 via part 27a of a data communications network;
a number of payment systems 39 associated with one or more EFT terminals 19. Each payment systems 39 runs on the appropriate banking servers 29 belonging to the financial institution 15 that established the payment system 39. The banking servers 29 are connected to the host transaction engine 25 via part 27b of the data communications network. The banking servers 29 are also interconnected to the EFT terminals 19, via link 27ab, so that the EFT terminals 19 can run a financial application 40 without need of host transaction engine 25;
an application 42 on the host transaction engine 25 that provides for the running of a plurality of electronic service packages (ESPs) 41 sourced from commercial providers 23. The ESPs 41 allow merchants 17 to offer products or services of the commercial provider 23 from whom the ESPs have been sourced. Commercial providers 23 are connected to the host transaction engine 25 via part 27c of the data communications network.
an EFT terminal architecture 37 allowing multiple applications to run on an EFT terminal 19 without jeopardising the security of an application;
a secure access module (SAM) 43 for loading on to each EFT terminal 19. The SAM 43 providing data security to the EFT terminal 19 commensurate with that required for financial transaction purposes and to provide an identifier for the merchant utilising the EFT terminal 19 for contractual and operational purposes;
a standard message format 45 for interaction between the EFT terminals 19 and the host transaction engine 25; and
a plurality of adapters 47 that allow the host transaction engine 25 to communicate between virtually any commercial provider system 31, EFT terminal 19 and payment system 39.

The host transaction engine 25 is an application written in Java™ that includes a set of tools to broker commercial provider's 23 services that can be rapidly deployed over the EFT terminals 19. In this sense the host transaction engine 25 effectively functions as a gateway to the ESP's 43. Being written in Java™, the host transaction engine 25 can be platform independent.

As shown in FIG. 3 of the drawings, the host transaction engine 25 is particularly designed to include a process automation engine (PAE) 49, a graphical process designer 51, a database engine 53, a reporting system 55, an access control and process management system 57 and a graphical message designer 59. In this configuration, the host transaction engine 25 is scalable, capable of operating between any number of computers and provides for redundancy to safeguard against failure. This configuration also allows the host transaction engine 25 to operate with alternative terminal devices, such as stand-alone terminals 19b and other devices 19c, such as mobile telephones and personal digital assistants.

In the embodiment described, there are three adapters 47 in use:
host-to-provider service adapter 47a;
EFT terminal-to-host device adapter 47b; and
Host-to-payment system adapter 47c.

Host-to-provider service adapter 47a translates messages to the native format of a provider system 31. EFT terminal-to-host device adapter 47b converts messages 48 from an EFT terminal-to-host format to XML as well as handling some security for the business system 11. The Host-to-payment system adapter 47c provides for secure communications between the host transaction engine 25 and the payment system 39 associated therewith.

The PAE 49 is a transaction engine that operates as an enabling means for organizing work between commercial provider systems 31, payment systems 39 and EFT terminals 19. The PAE 49 also operates to facilitate payment for transactions between commercial provider systems 31, payment systems 39 and EFT terminals 19 using the system. It should be noted, however, that the PAE 49 remains agnostic to the security and messaging relationship established with the commercial providers systems 31.

The host transaction engine 25 has a number of high-level processes that highlight the ease of use of the business system 11. Some of the most important of these, in the case of the present embodiment, are those associated with the messaging facility. The messaging facility provides for messages to deliver ESPs 41 over multiple devices, and those which are used for the purposes of creating a new ESP 41 for a prospective commercial provider 23.

In the present embodiment, the messaging facility is based on industry standard XML messaging. This not only makes it easier to deliver ESPs 41 over multiple EFT terminals 19, but also eases integration with legacy systems. The graphical message designer 59 allows a user to drag and drop fields to change the format and content of messages. With the graphical message designer 59, a message 48 can be changed to the friendliest possible format for a payment system 39 or commercial provider system 31. The graphical message designer 59 can also be used to graphically transform the values of fields between messages.

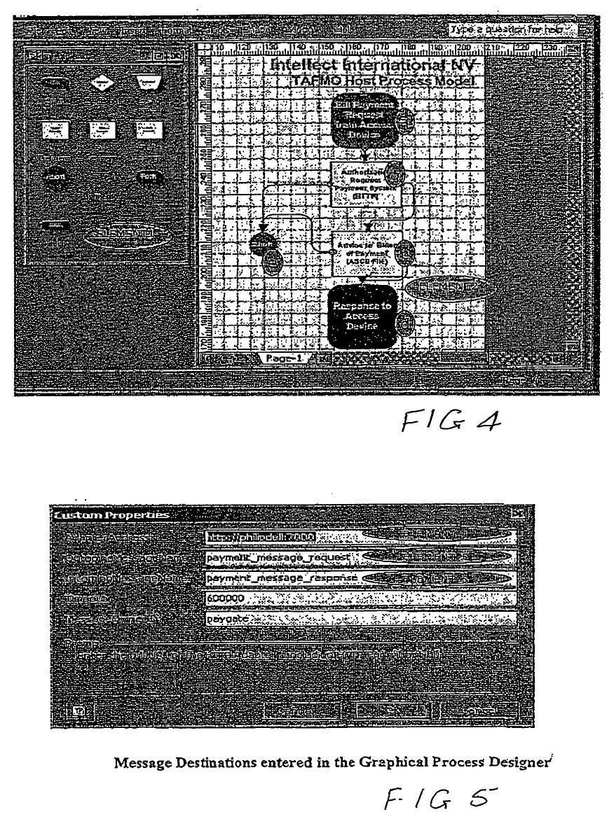

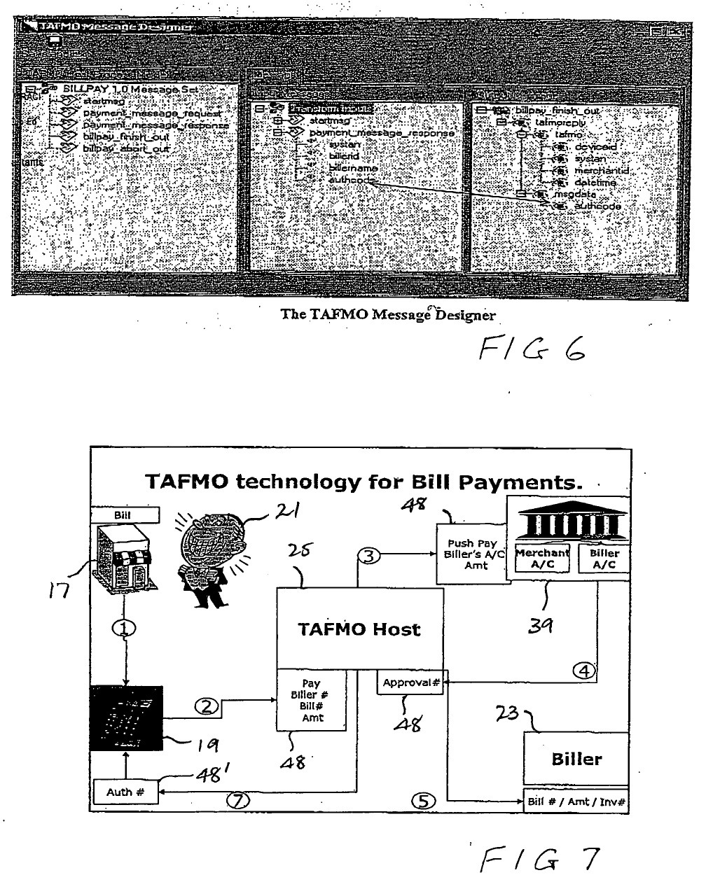

With reference to FIGS. 4 to 6, the need to initiate an ESP 41 for a commercial provider 23 will typically begin with a description of the service or product to be offered. This description then becomes the input to the new ESP process.

The process used to create a new ESP 41 usually consists of the following steps:—
1. Determine the messages and formats that pass between the host transaction engine 25 and the commercial provider system 31.
2. Draw a host transaction engine Process Model using the graphical process designer 51.
3. Design the content and transformations of messages using the message designer 59.
4. Test then deploy the new Process Model.
5. Manage the Process Model.

An example of the implementation of this process will now be described as indicated in FIG. 7. In this example, a customer 21 wishes to deliver a Bill Payments ESP 41 over EFT terminals 19 (step 1 in FIG. 7). The process would work as follows:
(a) The EFT terminal 19 sends a request to pay a bill along with payment details, such as the credit card number of the billed party, to the host transaction engine 25 (step 2 in FIG. 7).
(b) The host transaction engine 25 sends a request to the payment system 39 for approval on the credit card payment (step 3). The credit card system returns an approval code (step 4).
(c) The host transaction engine 25 then sends the biller (i.e. the commercial provider 23) advice that a payment has been collected in a form that the biller can easily integrate into a secure application program (step 5).
(d) The EFT terminal 19 is sent the approval code 48′ to print on the receipt (step 7).
(e) If anything goes wrong in the process, an error message is sent to the terminal 19.

The creation of an ESP will now be described in more detail with reference to the above example.

As shown in FIG. 4 of the drawings, the Process Model is created using special flow chart tools provided in the toolbox (element 1) of the graphical process designer 51. The process steps (a) to (e) shown in the drawing are correspondingly referenced according to the process example described above. These process steps are simply dragged from the toolbox to the workspace element 2).

After drawing the Process Model using the graphical process designer 51, the next step involves telling the Process Model to which adapter 47 each message 48 must be sent. In the present embodiment, double clicking the mouse button whilst on any one of the process steps (a) to (e) displayed in the graphical process designer 51 will open a dialog box as shown in FIG. 5. In the dialog box, the name of the adapter 47 to which the message 48 should be sent is entered (elements 4 and 5).

In the particular example shown in FIG. 5, step (b) from the example process is demonstrated. The dialog box shows the name of the adapter 47 associated with the payment system 39, the name of the message 48 to send to the payment system 39 and the name of the message it will receive as a response from the payment system 39.

The final creation stage is the design of the particular messages 48 specified in the previous step using the graphical message designer 59. In the present embodiment, message design is achieved by selecting a field that contains required data and moving an arrow to where the data is desired to be placed using the “drag and drop” method. The user can also perform message manipulations on messages that are returned from external systems.

Using the graphical message designer 59 to perform message translations is an important part of the functionality of the graphical message designer 59. Once all of the messages 48 have been designed and associated with the Process Model, the Process Model is loaded into the PAE 49. When activated, the Process Model will answer calls from the EFT terminals 19 requesting the ESP service.

Once the Process Model is active, the host transaction engine 25 provides a full set of reporting and management tools using the reporting system 55. The system administrator of the host transaction engine 25 can monitor performance of Process Models on a live or historical basis. Merchants 17, commercial providers 23 and customers 21 can view reports generated by reporting system 55 that are relevant to them on the Internet, on paper or via email.

As the business system 11 involves communicating with a payment system 39 electronically and transferring funds by electronic means, security is a fundamental requirement to be addressed to ensure “real world” operation. In the present embodiment, security is built in to the business system 11 by way of a number of different elements.

Firstly, with respect to the domain between the host transaction engine 25 and the EFT terminal 19, a SAM 43 is slotted into EFT terminals 19. The SAM 43 contains cryptographic keys for channel encryption, message authentication and data encryption. The SAM 43 module is consequently designed to support:
proof of endpoint;
message integrity checking;
data stamping; and
personal identification number (PIN) services.

With respect to the domain of the host transaction engine 25, three main security systems are provided. These are:
access security, which is controlled through each component of the system on a user/group/role basis.
perimeter security, which is maintained as a firewall—the firewall ensures that only certified user's Internet Protocol (IP) addresses can access relevant components of the system;
password security, which ensures that all access to any component of the host transaction engine 25 is controlled by password and user name logins—password and user name logins will also support authentication using the SAM 43.

With respect to the domain between host transaction engine 25 and the ESP 41, communication is secured by two systems. These include:
perimeter security, as in the domain of the host transaction engine 25, is maintained as a firewall;
additional security, which can be implemented in the domain of the ESP 41 to support the requirements of the commercial provider 23 that generated the ESP 41, or the sponsoring financial institution.

Thus the provision of a SAM 43 on the EFT terminal 19 will ease the certification process with the terminal sponsor in each country by:
providing a method of securing download to a terminal—the download mechanism ensures that a terminal sponsor is the only party capable of downloading applications to a terminal;
providing a prompt table service—this ensures that the terminal sponsor is the only party capable of displaying text messages on the screen of the terminal.
securely identifying the merchant 17 and holding their cryptographic keys.

Finally, data travelling through the host transaction engine 25 is captured in the database 53 and is securely made available to customers 21, merchants 17 and commercial providers 23 in reports. These reports are thereafter made accessible over the Internet, or other data communication network.

As a consequence of adopting the best mode, it should be noted that there are many advantages to the described system. These include:
1) With the ESP terminal application:
   a. the ability to live update value added service products that can be sold on an EFTPOS terminal; and.
   b. securely manage a banking application next to such a dynamic application.
2) With the EFT terminal 19 a SAM 43 that holds the security keys and personality of the business system application, which:
   a. legally binds the merchant who sells value added service offerings to the commercial broker and a debtors account. In the same manner as would a mobile phone SIM card to a telecommunications company;
   b. holds the cryptographic keys outside the financial system;
   c. secure way of giving the merchant an identity that is outside a bank's system.
3) With the host transaction engine business system or model—the present method of brokering deals between commercial providers 23 and terminal sponsors, to sell services over EFT terminals 19 or devices. This involves:
   a. approaching a commercial provider offering enhanced distribution.
   b. signing a contract where the commercial provider pays the business broker for access to the distribution channel on a revenue share or fee for transaction basis.
   c. selling the services that the commercial provider sells to the business broker, to the terminal sponsor.

It should be appreciated that the scope of the particular invention is not limited to the particular embodiment described herein and that many modifications or adaptations can be incorporated so as to further enhance or modify the system to a particular circumstance, but which do not depart from the spirit of the invention and thus remain within its scope. In particular, the present invention is not limited to application with EFT terminals, and indeed may be used with alternative devices such as mobile phones or personal digital assistants.

1. A method for electronically transacting a trade between a commercial provider and a customer of a merchant, and for electronically paying all of the participants involved with enabling the transaction from the payment made by the customer in consideration of the trade, the method comprising:
entering into an agreement with the commercial provider to provide a good or service to a potential customer of the merchant for valuable or other consideration;
entering into an agreement with the merchant to offer the good or service of the commercial provider to its customers for valuable or other consideration;
electronically transacting with the customer of the merchant the provision of the good or service of the commercial provider to the customer;
using an electronic payment system to handle payment of a good or service of the commercial provider purchased by a customer of the merchant;
electronically authorising the provision of the good or service of the commercial provider upon confirmation of payment by the electronic payment system;
electronically distributing the valuable consideration in respect of the payment to the commercial provider, if applicable, in accordance with the agreement made with the commercial provider; and
electronically distributing the valuable consideration in respect of the payment to the merchant, if applicable, in accordance with the agreement made with the merchant.

2. A method according to claim 1, further comprising the steps of:
entering into an agreement with a sponsor of a terminal device of the electronic payment system to use the terminal device in handling payment for a good or service of the commercial provider purchased by a customer of the merchant, agreement being provided in return for a prescribed proportion of the price of the good or service or fixed sum;
electronically distributing the prescribed proportion or fixed sum of the payment to the sponsor of the terminal device in accordance with the agreement made with the sponsor of the terminal device.

3. A method according to claim 1 where the step of using an electronic payment system to handle payment of a good or service of the commercial provider purchased by a customer of the merchant includes the sub-step of electronically drawing on an electronic bank account of the merchant to pay for the good or service of the commercial provider purchased by the customer.

4. A method for electronically transacting a trade between a commercial provider and a customer of a merchant, and for electronically paying all of the participants involved with enabling the transaction from the payment made by the customer in consideration of the trade, the method comprising:
entering into an agreement with the commercial provider to provide a good or service to a potential customer of the merchant for a prescribed proportion of the price of the good or service or for a fixed sum;
entering into an agreement with a sponsor of a terminal device of an electronic payment system to use the terminal device in handling payment for a good or service of the commercial provider purchased by a customer of the merchant, agreement being provided in return for a prescribed proportion of the price of the good or service or fixed sum;
electronically transacting with the customer the provision of the good or service of the commercial provider to a customer of the merchant;
using the electronic payment system to handling payment of a good or service of the commercial provider purchased by a customer of the merchant;
electronically authorising the provision of the good or service of the commercial provider upon confirmation of payment by the electronic payment system;
electronically distributing the prescribed proportion or fixed sum of the payment to the commercial provider in accordance with the agreement made with the commercial provider; and
electronically distributing the prescribed proportion or fixed sum of the payment to the owner of the terminal device in accordance with the agreement made with the sponsor of the terminal device.

5. A method as claimed in claim 1 or claim 4, wherein the terminal device is one of an EFT terminal, a mobile telephone or portable digital assistant.

6. A method as claimed in claim 5, wherein the primary payment for the good or service is paid for by way of an electronic transfer of funds from the payment system associated with the EFT terminal.

7. A method as claimed in claim 1 or claim 4, wherein the provider of the electronic authorising to the commercial provider for the provision of the good or service, the provider of the electronic transacting with the customer for the provision of the good or service to the customer, and the provider of the electronic distributing of the valuable consideration to the commercial provider and the merchant, if applicable, with the payment system, is the same provider.

8. A method as claimed in claim 7, wherein the provider contracts with the merchant to pay the merchant a sales commission for a good or service that the merchant is able to sell or provide to a customer.

9. A method as claimed in claim 7, wherein the merchant pays a fee to the provider for the provision of a good or service that adds value to the merchant's business.

10. A method as claimed in claim 7, wherein the primary payment for the provision of a good or service is paid for by way of an electronic transfer of funds from a payment system associated with the business broker.

11. A method as claimed in claim 1 or claim 4, wherein primary payment for the service or product may be paid for directly by the customer.

12. A method as claimed in claim 6, including the terminal device communicating the particular manner of the transacting payment to the provider, and the provider effecting the electronic distribution of the prescribed proportion based on the manner of such payment.

13. A method as claimed in claim 10, including the terminal device communicating the particular manner of the transacting payment to the provider, and the provider effecting the electronic distribution of the prescribed portion based on the manner of such payment.

14. A method as claimed in claim 11, including the terminal device communicating the particular manner of the transacting payment to the provider, and the provider effecting the electronic distribution of the prescribed portion based on the manner of such payment.

15. A system for electronically transacting a trade comprising:
a business broker who has entered into an agreement with:—
a. a commercial provider for the commercial provider to provide a good or service to a potential customer of a merchant for a prescribed proportion of the price of the good or service or for a fixed sum;
b. the merchant for the merchant to offer the good or service of the commercial provider to its customers for a prescribed proportion of the price of the good or service or fixed sum;
an electronic payment system for handling payment of a good or service of the commercial provider purchased by a customer of the merchant
where, the merchant authorises the provision of the good or service of the commercial provider upon confirmation of payment by the electronic payment system; and where the business broker receives the payment handled by the electronic payment system and electronically distributes the prescribed portion or fixed sum of the payment to the commercial provider in accordance with the agreement made with the commercial provider and electronically distributes the prescribed portion or fixed sum of the payment to the merchant in accordance with the agreement made with the merchant.

16. A system for electronically transacting a trade according to claim 15 where the electronic payment system includes at least one terminal device.

17. A system for electronically transacting a trade according to claim 16 where the at least one terminal device is one of: EFT terminal; mobile phone; personal digital assistant.

18. A system for electronically transacting a trade according to claim 16 where the business broker has also entered into an agreement with an owner of the at least one terminal device to use the terminal device in handling payment for a good or service of the commercial provider purchased by a customer of the merchant, agreement being provided in return for a prescribed proportion of the price of the good or service or fixed sum and where the commercial provider electronically distributes the prescribed portion or fixed sum of the payment to the merchant in accordance with the agreement made with the merchant.

19. A system for electronically transacting a trade according to claim 15, where the electronic payment network draws on an electronic bank account of the merchant to pay for the good or service of the commercial provider purchased by the customer.

20. A system for electronically transacting a trade comprising:
a business broker who has entered into an agreement with:—
a. a commercial provider for the commercial provider to provide a good or service to a potential customer of a merchant for a prescribed proportion of the price of the good or service or for fixed sum;
b. an owner of a terminal device of an electronic payment system to use the terminal device in handling payment for a good or service of the commercial provider purchased by a customer of a merchant, agreement being provided in return for a prescribed proportion of the price of the good or service or for a fixed sum;
an electronic payment system for handling payment of a good or service of the commercial provider purchased by a customer of the merchant
where, the merchant authorises the provision of the good or service of the commercial provider upon confirmation of payment by the electronic payment system; and where the business broker receives the payment handled by the electronic payment system and electronically distributes the prescribed portion or fixed sum of the payment to the commercial provider in accordance with the agreement made with the commercial provider and electronically distributes the prescribed portion or fixed sum of the payment to the owner of the terminal device in accordance with the agreement made with the owner of the terminal device.

21. A system for electronically transacting a trade between a commercial provider and a customer of a merchant and for electronically paying all of the participants involved with enabling the transaction from the payment made by the customer in consideration of the trade, the system comprising:
a host transaction engine for controlling electronic transactions between a business broker, a merchant, a customer of the merchant, a commercial service provider and a terminal device sponsor;
a terminal device for connection to the host transaction engine, the terminal device being provided with the merchant and associated with a payment system established with the terminal device by a sponsor thereof for the purposes of performing electronic transactions in connection with the trade of the merchant; and
a provider system for connection to the host transaction engine, the provider system being adapted to provide for communications between the host transaction engine and the commercial provider to enable the provision of a transacted service or product;
wherein the host transaction engine has enabling means to electronically enable the provision of the transacted service or product by the commercial provider in response to confirmation of the customer paying for the same; and
said host transaction means has paying means to electronically account for an distribute prescribed portions of funds to the commercial provider, the merchant and the business broker in accordance with predetermined contractual arrangements with these parties.

22. A system according to claim 21, where the terminal device is one of: EFT terminal; mobile telephone; personal digital assistant.

23. A system according to claim 21, where the host transaction engine also provides for an electronic transfer of funds from the payment system in response to a transaction in relation to the provision of a commercial provider's service or product.

24. A system according to claim 21, where primary payment for the provision of the service or product transacted is effected directly between the terminal device of the merchant and the payment system and wherein the host transaction engine effects subsequent payment of the commercial provider and the terminal owner.

25. A system according to claim 21, further comprising a payment system server connected to the host transaction engine, the payment system server providing for an electronic transfer of funds from the payment system in response to a transaction in relation to the provision of a service or product communication between the EFT terminal and the host transaction engine, and between the host transaction engine and the payment system, as authorised by the payment system.

26. A host transaction engine comprising:
a process automation engine; and
at least one adapter for receiving a message;
where the at least one adapter translates the message into a format able to be processed by the process automation engine and the process automation engine processes the message in accordance with a predetermined process model.
